(19) United States
(12) Patent Application Publication
(10) Pub. No.: US 2017/0140714 A1
(43) Pub. Date: May 18, 2017

(54) LIQUID CRYSTAL DISPLAY PANEL AND ARRAY SUBSTRATE

(71) Applicant: SHENZHEN CHINA STAR OPTOELECTRONICS TECHNOLOGY CO., LTD., Shenzhen, Guangdong (CN)

(72) Inventors: Bing HAN, Shenzhen, Guangdong (CN); Jinjie WANG, Shenzhen, Guangdong (CN)

(73) Assignee: Shenzhen China Star Optoelectronics Technology Co., Ltd., Shenzhen, Guangdong (CN)

(21) Appl. No.: 14/437,488

(22) PCT Filed: Jan. 9, 2015
(86) PCT No.: PCT/CN2015/070439

§ 371 Date: Apr. 21, 2015

(30) Foreign Application Priority Data
Nov. 21, 2014 (CN) 201410677501.3

(51) Int. Cl. G09G 3/36; G02F 1/1368; G02F 1/1362

(52) U.S. Cl. CPC G09G 3/3607; G09G 3/3677; G02F 1/136286; G02F 1/136213; G02F 1/1368; G02F 1/13624; G09G 2300/0871; G02F 2201/123; G02F 2201/121

(57) ABSTRACT

A liquid crystal display panel and an array substrate. The liquid crystal display panel includes a first substrate, a second substrate, and a liquid crystal layer. The first substrate includes multiple scanning lines and data lines. Each of the pixel areas includes a first sub-pixel area, a second sub-pixel area, and a third sub-pixel area. Driving voltages of the first sub-pixel area, the second sub-pixel area, and the third sub-pixel area are all generated from a data voltage provided by a same data line corresponding to the pixel area. When driving, the driving voltage of the first sub-pixel area is greater than the driving voltage of the second sub-pixel area, and the driving voltage of the second sub-pixel area is greater than the driving voltage of the third sub-pixel area. The color shift problem at a large viewing angle can be solved, and simplifying the circuit and reducing the cost.

### BACKGROUND OF THE INVENTION

1. Field of the Invention

The present invention relates to a liquid crystal display device, and more particular to a liquid crystal display panel and an array substrate.

2. Description of Related Art

Because the internal factor of the liquid crystal display, a picture observed at different viewing angle always exists some difference. A picture is normal when observed at a front viewing angle, but the picture become abnormal when observed at a large viewing angle, which is the color shift problem when viewing at a large viewing angle.

In order to improve this situation, in the conventional art, a pixel is divided into three sub-pixel units. In this design, three scanning lines provide scanning signals and three data lines provide different signal voltages. However, the frequency of the data signal is three times the frequency of the scanning signal. Besides, the circuit become complex and increase the design cost.

### SUMMARY OF THE INVENTION

The main technology solved by the present invention is to provide a liquid crystal display panel and an array substrate in order to solve the color shift problem at a large viewing angle, and simplify the circuit design and reduce the cost at the same time.

In order to solve the above technology problem, a technology solution adopted by the present invention is: a liquid crystal display panel, comprising: a first substrate, having: multiple scanning lines disposed on the first substrate; multiple data lines disposed on the first substrate, wherein, the multiple scanning lines and multiple data lines are crossed with each other such that the liquid crystal display panel is divided into multiple pixel areas; a second substrate disposed oppositely to the first substrate; and a liquid crystal layer disposed between the first substrate and the second substrate; wherein, each of the pixel areas includes a first sub-pixel area, a second sub-pixel area, and a third sub-pixel area; a driving voltage of the first sub-pixel area, a driving voltage of the second sub-pixel area, and a driving voltage of the third sub-pixel area are all generated from a data voltage provided by a same data line corresponding to the pixel area; when driving, the driving voltage of the first sub-pixel area is greater than the driving voltage of the second sub-pixel area, and the driving voltage of the second sub-pixel area is greater than the driving voltage of the third sub-pixel area.

Wherein, the first sub-pixel area and the second sub-pixel area are respectively connected with a scanning line corresponding to the pixel area and a data line corresponding to the pixel area such that the scanning line corresponding to the sub-pixel areas can control the first sub-pixel area and the second sub-pixel area to be turned on and turned off; when the first sub-pixel area and the second sub-pixel area are turned on, using the data line corresponding to the pixel area to respectively input a data voltage into the first sub-pixel area and the second sub-pixel area; the third sub-pixel area is connected with a next scanning line adjacent to the scanning corresponding to the pixel area such that the next scanning line can control the third sub-pixel area to be turned on and turned off; after the data voltage is inputted into the first sub-pixel area and the second sub-pixel area and the third sub-pixel area is turned on, the second sub-pixel area charge the third sub-pixel area so as to pull down the driving voltage of the second sub-pixel area; and when the third sub-pixel area is turned off, the third sub-pixel area pulls down the driving voltage of the third sub-pixel area according to an electric charge coupling effect.

Wherein, the first sub-pixel area includes a first switch element, a first liquid crystal capacitor, and a first storage capacitor; the second sub-pixel area includes a second switch element, a second liquid crystal capacitor, and a second storage capacitor; the third sub-pixel area includes a third switch element, a third liquid crystal capacitor, and a third storage capacitor; wherein, both gates of the first switch element and the second switch element of the first sub-pixel area and the second sub-pixel area are electrically connected with the scanning line corresponding to the pixel area; both sources of the first switch element and the second switch element are electrically connected with the data line corresponding to the pixel area; a drain of the first switch element of the first sub-pixel area is electrically connected with a first terminal of each of the first liquid crystal capacitor and the first storage capacitor of the first sub-pixel area; a drain of the second switch element of the second sub-pixel area is electrically connected with a first terminal of each of the second liquid crystal capacitor and the second storage capacitor of the second sub-pixel area; and a gate of the third switch element of the third sub-pixel area is electrically connected with the next scanning line adjacent to the scanning line corresponding to the pixel area; a source of the third switch element is electrically connected with the first terminal of each of the second liquid crystal capacitor and the second storage capacitor of the second sub-pixel area; a drain of the third switch element is electrically connected with a first terminal of each of the third liquid crystal capacitor and the third storage capacitor; a second terminal of each of the first storage capacitor and the second storage capacitor is electrically connected with a common line; a second terminal of the third storage capacitor of the third sub-pixel area is electrically connected with the next scanning line adjacent to the scanning line corresponding to the pixel area.

Wherein, the first switch element of the first sub-pixel area and the second switch element of the second sub-pixel area a same switching element.

Wherein, each of the first switch element, the second switch element, and the third switch element of the first sub-pixel area, the second sub-pixel area, and the third sub-pixel area is realized by a thin-film-transistor.

Wherein, a pixel electrode of each pixel area is divided into a first sub-pixel electrode, a second sub-pixel electrode, and a third sub-pixel electrode; the first sub-pixel electrode, the second sub-pixel electrode, and the third sub-pixel electrode are respectively the first terminal of the first liquid crystal capacitor of the first sub-pixel area, the first terminal of the second liquid crystal capacitor of the second sub-pixel area, and the first terminal of the third liquid crystal capacitor of the third sub-pixel area; a common electrode of the pixel area is corresponding as the second terminal of the first liquid crystal capacitor of the first sub-pixel area, the second terminal of the second liquid crystal capacitor of the second sub-pixel area, and the second terminal of the third liquid crystal capacitor of the third sub-pixel area. Wherein, the pixel electrode and the common electrode of each pixel area are disposed on the first substrate.

In order to solve the above technology problem, another technology problem solution adopted by the present invention is: an array substrate, comprising: multiple scanning lines; multiple data lines, wherein, the multiple scanning lines and multiple data lines are crossed with each other such that the array substrate is divided into multiple pixel areas; wherein, each of the pixel areas includes a first sub-pixel area, a second sub-pixel area, and a third sub-pixel area; a driving voltage of the first sub-pixel area, a driving voltage of the second sub-pixel area, and a driving voltage of the third sub-pixel area are all generated from a data voltage provided by a same data line corresponding to the pixel area; when driving, the driving voltage of the first sub-pixel area is greater than the driving voltage of the second sub-pixel area, and the driving voltage of the second sub-pixel area is greater than the driving voltage of the third sub-pixel area.

Wherein, the first sub-pixel area and the second sub-pixel area are respectively connected with a scanning line corresponding to the pixel area and a data line corresponding to the pixel area such that the scanning line corresponding to the sub-pixel areas can control the first sub-pixel area and the second sub-pixel area to be turned on and turned off; when the first sub-pixel area and the second sub-pixel area are turned on, using the data line corresponding to the pixel area to respectively input a data voltage into the first sub-pixel area and the second sub-pixel area; the third sub-pixel area is connected with a next scanning line adjacent to the scanning corresponding to the pixel area such that the next scanning line can control the third sub-pixel area to be turned on and turned off; after the data voltage is inputted into the first sub-pixel area and the second sub-pixel area and the third sub-pixel area is turned on, the second sub-pixel area charge the third sub-pixel area so as to pull down the driving voltage of the second sub-pixel area; and when the third sub-pixel area is turned off, the third sub-pixel area pulls down the driving voltage of the third sub-pixel area according to an electric charge coupling effect.

Wherein, the first sub-pixel area includes a first switch element and a first storage capacitor; the second sub-pixel area includes a second switch element and a second storage capacitor; the third sub-pixel area includes a third switch element and a third storage capacitor; wherein, both gates of the first switch element and the second switch element of the first sub-pixel area and the second sub-pixel area are electrically connected with the scanning line corresponding to the pixel area; both sources of the first switch element and the second switch element are electrically connected with the data line corresponding to the pixel area; a drain of the first switch element of the first sub-pixel area is electrically connected with a first terminal of the first storage capacitor of the first sub-pixel area; a drain of the second switch element of the second sub-pixel area is electrically connected with a first terminal of the second storage capacitor of the second sub-pixel area; and a gate of the third switch element of the third sub-pixel area is electrically connected with the next scanning line adjacent to the scanning line corresponding to the pixel area; a source of the third switch element is electrically connected with the first terminal of the second storage capacitor of the second sub-pixel area; a drain of the third switch element is electrically connected with a first terminal of the third storage capacitor; a second terminal of each of the first storage capacitor and the second storage capacitor is electrically connected with a common line; a second terminal of the third storage capacitor of the third sub-pixel area is electrically connected with the next scanning line adjacent to the scanning line corresponding to the pixel area.

The beneficial effect of the present invention is: comparing to the conventional art, the present invention divides each pixel area into three sub-pixel area. When driving, three driving voltages of the first sub-pixel area, the second sub-pixel area, and the third sub-pixel area are different. In the present embodiment, the driving voltage of the first sub-pixel area is greater than the driving voltage of the second sub-pixel area, and the driving voltage of the second sub-pixel area is greater than the driving voltage of the third sub-pixel area. The color shift problem at a large viewing angle is effectively improved. At the same time, in the present invention, the driving voltage of each of the first sub-pixel area, the second sub-pixel area, and the third sub-pixel area is generated from the data voltage provided by the same data line. The situation of using three different data lines for three sub-pixel areas is avoid such that the circuit design is simplified and the cost is decreased.

### BRIEF DESCRIPTION OF THE DRAWINGS

FIG. 1 is an equivalent circuit of a first substrate of a liquid crystal display panel according to an embodiment of the present invention; and

FIG. 2 is an equivalent circuit of an array substrate according to an embodiment of the present invention.

### DETAILED DESCRIPTION OF THE PREFERRED EMBODIMENT

The following will combine drawings and embodiments for detailed description of the present invention.

The present invention provides a liquid crystal display panel. The panel includes a first substrate, a second substrate, and a liquid crystal layer disposed between the first substrate and the second substrate. The first substrate is provided with multiple scanning lines and multiple data lines. The multiple scanning lines and multiple data lines are disposed on a surface of the first substrate adjacent to the liquid crystal layer. The multiple scanning lines and multiple data lines are crossed with each other such that the liquid crystal display panel is divided into multiple pixel areas. Generally, the multiple data lines are disposed in parallel with each other, and the multiple scanning lines are disposed in parallel with each other. The multiple scanning lines and multiple data lines are crossed and perpendicular with each other. In another embodiment, the multiple scanning lines and multiple data lines can be disposed by other arrangements.

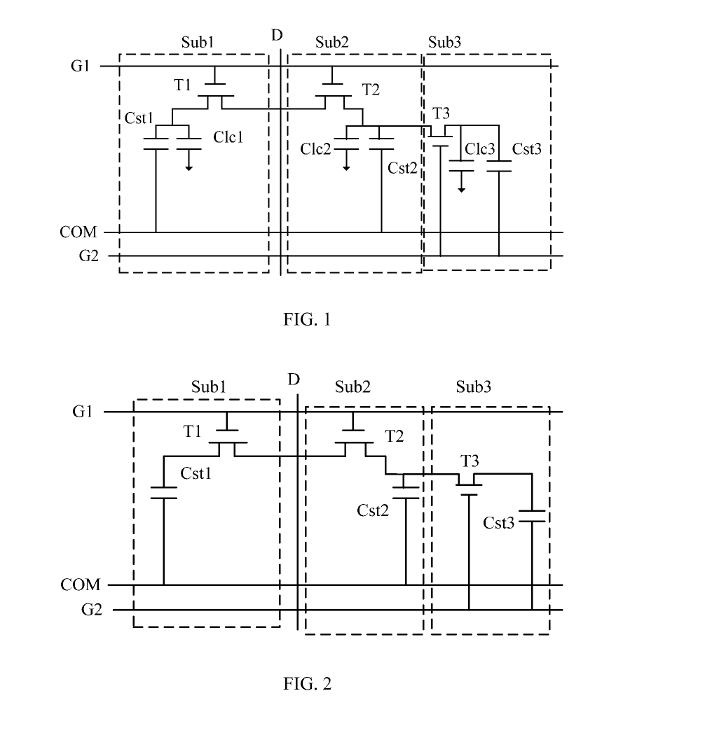

As shown in FIG. 1, each of the pixel area is divided into three sub-pixel areas: a first sub-pixel area Sub1, a second sub-pixel area Sub2, and a third sub-pixel area Sub3. A driving voltage of each of the first sub-pixel area Sub1, the second sub-pixel area Sub2, and the third sub-pixel area Sub3 is generated from a data voltage (i.e. pixel voltage or display voltage) provided by a same data line D. That is, corresponding to the first sub-pixel area Sub1, the second sub-pixel area Sub2, and the third sub-pixel area Sub3, only one data line D is provided. Besides, when driving, three driving voltages of the first sub-pixel area Sub1, the second sub-pixel area Sub2, and the third sub-pixel area Sub3 are different. In the present embodiment, the driving voltage of the first sub-pixel area Sub1 is greater than the driving voltage of the second sub-pixel area Sub2, and the driving voltage of the second sub-pixel area Sub2 is greater than the driving voltage of the third sub-pixel area Sub3.

Comparing to the conventional art, the present invention divides each pixel area into three sub-pixel area. When driving, three driving voltages of the first sub-pixel area Sub1, the second sub-pixel area Sub2, and the third sub-pixel area Sub3 are different. In the present embodiment, the driving voltage of the first sub-pixel area Sub1 is greater than the driving voltage of the second sub-pixel area Sub2, and the driving voltage of the second sub-pixel area Sub2 is greater than the driving voltage of the third sub-pixel area Sub3. The color shift problem at a large viewing angle is effectively improved. At the same time, in the present invention, the driving voltage of each of the first sub-pixel area Sub1, the second sub-pixel area Sub2, and the third sub-pixel area Sub3 is generated from the data voltage provided by the same data line D. The situation of using three different data lines for three sub-pixel areas is avoid such that the circuit design is simplified and the cost is decreased.

Wherein, the first sub-pixel area Sub1 and the second sub-pixel area Sub2 are respectively connected with a scanning line G1 corresponding to the pixel area and a data line D corresponding to the pixel area such that the scanning line G1 corresponding to the pixel area can control the first sub-pixel area Sub1 and the second sub-pixel area Sub2 to be turned on and turned off. Besides, when the first sub-pixel area Sub1 and the second sub-pixel area Sub2 are turned on, using the data line D corresponding to the pixel area to respectively input a data voltage into the first sub-pixel area Sub1 and the second sub-pixel area Sub2. Currently, the driving voltages of the first sub-pixel area Sub1 and the second sub-pixel area Sub2 are the same.

The third sub-pixel area Sub3 is connected with a next scanning line G2 adjacent to the scanning G1 corresponding to the pixel area such that the scanning line G2 can control the third sub-pixel area Sub3 to be turned on and turned off. After the data voltage is inputted into the first sub-pixel area Sub1 and the second sub-pixel area Sub2 and the third sub-pixel area Sub3 is turned on, the second sub-pixel area Sub2 charge the third sub-pixel area Sub3 so as to pull down the driving voltage of the second sub-pixel area Sub2 such that the driving voltage of the second sub-pixel area Sub2 is smaller than the driving voltage of the first sub-pixel area Sub1. When the third sub-pixel area Sub3 is turned off, the third sub-pixel area Sub3 pulls down the driving voltage of the third sub-pixel area Sub3 according to an electric charge coupling effect such that the driving voltage of the third sub-pixel area Sub3 is smaller than the driving voltage of the second sub-pixel area Sub2.

Wherein, each of the first sub-pixel area Sub1, the second sub-pixel area Sub2, and the third sub-pixel area Sub3 includes a switch element, a liquid crystal capacitor, and a storage capacitor. Respectively, the first sub-pixel area Sub1 includes a first switch element T1, a first liquid crystal capacitor C1c1, and a first storage capacitor Cst1; the second sub-pixel area Sub2 includes a second switch element T2, a second liquid crystal capacitor C1c2, and a second storage capacitor Cst2; the third sub-pixel area Sub3 includes a third switch element T3, a third liquid crystal capacitor C1c3, and a third storage capacitor Cst3. The switch elements T1, T2, T3 control the first sub-pixel area Sub1, the second sub-pixel area Sub2, and the third sub-pixel area Sub3 to be turned on and turned off. Each of the liquid crystal capacitors C1c1, C1c2, C1c3 is a capacitor generated by the liquid crystal layer which is disposed between the first substrate and the second substrate.

Both gates of the first switch element T1 and the second switch element T2 of the first sub-pixel area Sub1 and the second sub-pixel area Sub2 are electrically connected with the scanning line G1 corresponding to the pixel area. Both sources of the first switch element T1 and the second switch element T2 are electrically connected with the data line corresponding to the pixel area. A drain of the first switch element T1 of the first sub-pixel area Sub1 is electrically connected with a first terminal of the first liquid crystal capacitor C1c1 and a first terminal of the first storage capacitor Cst1 of the first sub-pixel area Sub1. A drain of the second switch element T2 of the second sub-pixel area Sub2 is electrically connected with a first terminal of the second liquid crystal capacitor C1c2 and a first terminal of the second storage capacitor Cst2 of the second sub-pixel area Sub2.

A gate of the third switch element T3 of the third sub-pixel area Sub3 is electrically connected with a next scanning line G2 adjacent to the scanning line G1 corresponding to the pixel area. A source of the third switch element T3 is electrically connected with the first terminal of the second liquid crystal capacitor C1c2 and the first terminal of the second storage capacitor Cst2 of the second sub-pixel area Sub2. A drain of the third switch element T3 is electrically connected with a first terminal of the third liquid crystal capacitor C1c3 and a first terminal of the third storage capacitor Cst3. A second terminal of each of the first storage capacitor Cst1 and the second storage capacitor Cst2 is electrically connected with a common line COM. The voltage of the common line COM and the voltage of a common electrode layer on the second substrate are the same. A second terminal of the third storage capacitor Cst3 of the third sub-pixel area Sub3 is electrically connected with the next scanning line G2 adjacent to the scanning line G1 corresponding to the pixel area.

When a scanning signal scans to the scanning line G1 corresponding to the pixel area. The first switch element T1 corresponding to the first sub-pixel area Sub1 and the second switch element T2 corresponding to the second sub-pixel area Sub2 are turned on. The data line corresponding to the pixel area charges to the first liquid crystal capacitor C1c1, the first storage capacitor Cst1, the second liquid crystal capacitor C1c2, and the second storage capacitor Cst2 through the first switch element T1 and the second switch element T2 such that both driving voltages of the first sub-pixel area Sub1 and the second sub-pixel area Sub2 are the same.

When the scanning signal scans to the next scanning line G2 adjacent to the scanning line G1 corresponding to the pixel area, the third switch element T3 is turned on, the second liquid crystal capacitor C1c2 and the second storage capacitor Cst2 charges to the third liquid crystal capacitor C1c3 and the third storage capacitor Cst3 through the third switch element T3 such that the driving voltage of the second sub-pixel area Sub2 becomes smaller than the driving voltage of the first sub-pixel area Sub1. When the scanning signal continues to scan to a next scanning line (next to G2), the voltage the scanning line G2 adjacent to the scanning line G1 corresponding to the pixel area is decreased. Because the second terminal of the third storage capacitor Cst3 is connected with the scanning line G2 so that the voltage of the third storage capacitor Cst3 is also decreased. In addition, the third storage capacitor Cst3 also pulls down the voltage of the third liquid crystal capacitor C1c3 connected with the third storage capacitor Cst3 such that the driving voltage of the third sub-pixel area Sub3 is decreased to be smaller than the driving voltage of the second sub-pixel area Sub2.

Wherein, in another embodiment, the switch element of the first sub-pixel area Sub1 and the switch element of the second sub-pixel area Sub2 are the same (not shown in the figure). That is, the first sub-pixel area Sub1 and the second sub-pixel area Sub2 commonly use one switch element in order to simplify the design and reduce the cost.

In this case, a gate of the one switch element is electrically connected with the scanning line G1 corresponding to the pixel area. A source of the one switch element is electrically connected with the data line corresponding to the pixel area. A drain of the one switch element is respectively connected with a first terminal of the first liquid crystal capacitor C1c1 and the first storage capacitor Cst1 of the first sub-pixel area Sub1, and connected with a first terminal of the second liquid crystal capacitor C1c2 and the second storage capacitor Cst2 of the second sub-pixel area Sub2. A gate of the third switch element T3 of the third sub-pixel area Sub3 is electrically connected with a next scanning line G2 adjacent to the scanning line G1 corresponding to the pixel area. A source of the third switch element T3 is electrically connected with a first terminal of the second liquid crystal capacitor C1c2 and the second storage capacitor Cst2 of the second sub-pixel area Sub2. A drain of the third switch element T3 is electrically connected with a first terminal of the third liquid crystal capacitor C1c3 and the third storage capacitor Cst3. A second terminal of each of the first storage capacitor Cst1 and the second storage capacitor Cst2 is electrically connected with a common line COM. The voltage of the common line COM and the voltage of a common electrode layer on the second substrate are the same. A second terminal of the third storage capacitor Cst3 of the third sub-pixel area Sub3 is electrically connected with the next scanning line G2 adjacent to the scanning line G1 corresponding to the pixel area.

Wherein, each of the first switch element T1, the second switch element T2, the third switch element T3 of the first sub-pixel area Sub1, the second sub-pixel area Sub2, and the third sub-pixel area Sub3 is realized by a thin-film-transistor.

Wherein, a pixel electrode of each pixel area is divided into a first sub-pixel electrode, a second sub-pixel electrode, and a third sub-pixel electrode. The first sub-pixel electrode, the second sub-pixel electrode, and the third sub-pixel electrode are respectively first terminals of the liquid crystal capacitors of the first sub-pixel area Sub1, the second sub-pixel area Sub2, and the third sub-pixel area Sub3. The common electrode of the pixel area is corresponding as second terminals of the liquid crystal capacitors of the first sub-pixel area Sub1, the second sub-pixel area Sub2, and the third sub-pixel area Sub3.

Wherein, the pixel electrode and the common electrode of each of the pixel area are disposed on the first substrate.

The specific manufacturing process for the first substrate is: on a glass substrate, through exposing, developing, and etching to form a PEP1 (photo-etching-process) layer as a scanning line electrode and a common electrode. Forming a PEP2 layer at a location of a TFT (Thin Film Transistor). Utilizing a metal material to form a data line electrode and the TFT. Forming a conductive hole at a location which is required to be conductive, that is, a PEP4 layer. Finally, finishing a pixel electrode, that is, ITO layer (i.e. PEP5).

Another embodiment of the present invention provides an array substrate. The array substrate includes multiple scanning lines and multiple data lines. The multiple scanning lines and multiple data lines are disposed on a surface of the array substrate. The multiple scanning lines and multiple data lines are crossed with each other such that the liquid crystal display panel is divided into multiple pixel areas. Generally, the multiple data lines are disposed in parallel with each other, and the multiple scanning lines are disposed in parallel with each other. The multiple scanning lines and multiple data lines are crossed and perpendicular with each other. In another embodiment, the multiple scanning lines and multiple data lines can be disposed by other arrangements.

With reference to FIG. 2, each of the pixel area is divided into three sub-pixel areas: a first sub-pixel area Sub1, a second sub-pixel area Sub2, and a third sub-pixel area Sub3. A driving voltage of each of the first sub-pixel area Sub1, the second sub-pixel area Sub2, and the third sub-pixel area Sub3 is generated from a data voltage (i.e. pixel voltage or display voltage) provided by a same data line D corresponding to the pixel area. That is, corresponding to the first sub-pixel area Sub1, the second sub-pixel area Sub2, and the third sub-pixel area Sub3, only one data line D is provided. Besides, when driving, three driving voltages of the first sub-pixel area Sub1, the second sub-pixel area Sub2, and the third sub-pixel area Sub3 are different. In the present embodiment, the driving voltage of the first sub-pixel area Sub1 is greater than the driving voltage of the second sub-pixel area Sub2, and the driving voltage of the second sub-pixel area Sub2 is greater than the driving voltage of the third sub-pixel area Sub3.

Comparing to the prior art, the present invention divides each pixel area into three sub-pixel areas. When driving, three driving voltages of the first sub-pixel area Sub1, the second sub-pixel area Sub2, and the third sub-pixel area Sub3 are different. In the present embodiment, the driving voltage of the first sub-pixel area Sub1 is greater than the driving voltage of the second sub-pixel area Sub2, and the driving voltage of the second sub-pixel area Sub2 is greater than the driving voltage of the third sub-pixel area Sub3. The color shift problem at a large viewing angle is effectively improved. At the same time, in the present invention, the driving voltage of each of the first sub-pixel area Sub1, the second sub-pixel area Sub2, and the third sub-pixel area Sub3 is generated from the data voltage provided by the same data line D corresponding to the pixel area. The situation of using three different data lines for three sub-pixel areas is avoid such that the circuit design is simplified and the cost is decreased.

Wherein, the first sub-pixel area Sub1 and the second sub-pixel area Sub2 are respectively connected with a scanning line G1 corresponding to the pixel area and a data line D corresponding to the pixel area such that the scanning line G1 corresponding to the pixel area can control the first sub-pixel area Sub1 and the second sub-pixel area Sub2 to be turned on and turned off. Besides, when the first sub-pixel area Sub1 and the second sub-pixel area Sub2 are turned on, using the data line D corresponding to the pixel area to respectively input a data voltage into the first sub-pixel area Sub1 and the second sub-pixel area Sub2. Currently, the driving voltages of the first sub-pixel area Sub1 and the second sub-pixel area Sub2 are the same.

The third sub-pixel area Sub3 is connected with a next scanning line G2 adjacent to the scanning G1 corresponding to the pixel area and the second sub-pixel area Sub2 such that the scanning line G2 can control the third sub-pixel area Sub3 to be turned on and turned off. After the data voltage is inputted into the first sub-pixel area Sub1 and the second sub-pixel area Sub2, and the third sub-pixel area Sub3 is turned on, the second sub-pixel area Sub2 charges to the third sub-pixel area Sub3 so as to pull down the driving voltage of the second sub-pixel area Sub2 such that the driving voltage of the second sub-pixel area Sub2 is smaller than the driving voltage of the first sub-pixel area Sub1. When the third sub-pixel area Sub3 is turned off, the third sub-pixel area Sub3 pulls down the driving voltage of the third sub-pixel area Sub3 according to an electric charge coupling effect such that the driving voltage of the third sub-pixel area Sub3 is smaller than the driving voltage of the second sub-pixel area Sub2.

Wherein, each of the first sub-pixel area Sub1, the second sub-pixel area Sub2, and the third sub-pixel area Sub3 includes switch elements T1, T2, T3 and storage capacitors Cst1, Cst2, Cst3. The switch elements are utilized to control the first sub-pixel area Sub1, the second sub-pixel area Sub2, and the third sub-pixel area Sub3 to be turned on and turned off.

The switch elements T1, T2 of the first sub-pixel area Sub1 and the second sub-pixel area Sub2 are both electrically connected with the scanning line G1 corresponding to the pixel area. Both source of the switch elements T1, T2 are connected with the data line D corresponding to the pixel area. A drain of the switch element T1 of the first sub-pixel area Sub1 is connected with a first terminal of the storage capacitor Cst1. A drain of the switch element T2 of the second sub-pixel area Sub2 is connected with a first terminal of the storage capacitor Cst2.

A gate of the switch element T3 of the third sub-pixel area Sub3 is electrically connected with a next scanning line G2 adjacent to the scanning line G1 corresponding to the pixel area. A source of the switch element T3 is electrically connected with the first terminal of the storage capacitor Cst2 of the second sub-pixel area Sub2. A drain of the switch element T3 is electrically connected with a first terminal of the storage capacitor Cst3 of the third sub-pixel area Sub3. A second terminal of each of the storage capacitors of the first sub-pixel area Sub1 and the second sub-pixel area Sub2 is electrically connected with a common line COM. A second terminal of the storage capacitor Cst3 of the third pixel area Sub3 is electrically connected with the next scanning line G2 adjacent to the scanning line G1 corresponding to the pixel area.

When a scanning signal scans to the scanning line G1 corresponding to the pixel area. The switch element T1 corresponding to the first sub-pixel area Sub1 and the switch element T2 corresponding to the second sub-pixel area Sub2 are turned on. The data line corresponding to the pixel area charges to the storage capacitors Cst1, Cst2 of the first sub-pixel area Sub1 and the second sub-pixel area Sub2 through the switch element T1 and the switch element T2 such that both driving voltages of the first sub-pixel area Sub1 and the second sub-pixel area Sub2 are the same.

When the scanning signal scans to the next scanning line G2 adjacent to the scanning line G1 corresponding to the pixel area, the third switch element T3 is turned on, the storage capacitor Cst2 of the second sub-pixel area Sub2 charges to the storage capacitor Cst3 of the third sub-pixel area Sub3 through the switch element T3 such that the driving voltage of the second sub-pixel area Sub2 becomes smaller than the driving voltage of the first sub-pixel area Sub1. When the scanning signal continues to scan to a next scanning line (next to G2), the voltage of the scanning line G2 adjacent to the scanning line G1 corresponding to the pixel area is decreased. Because the scanning line G2 is also connected with the storage capacitor Cst3 of the third sub-pixel area Sub3, the voltage of the storage capacitor Cst3 is also decreased such that the driving voltage of the third sub-pixel area Sub3 is decreased to be smaller than the driving voltage of the second sub-pixel area Sub2.

Wherein, in another embodiment, the switch element of the first sub-pixel area Sub1 and the switch element of the second sub-pixel area Sub2 are the same (not shown in the figure). That is, the first sub-pixel area Sub1 and the second sub-pixel area Sub2 commonly use one switch element in order to simplify the design and reduce the cost.

In this situation, a gate of the one switch element is electrically connected with the scanning line G1 corresponding to the pixel area. A source of the one switch element is electrically connected with the data line corresponding to the pixel area. A drain of the one switch element is respectively connected with a first terminal of the storage capacitor Cst1 of the first sub-pixel area Sub1 and a first terminal of the storage capacitor Cst2 of the second sub-pixel area Sub2. A gate of the third switch element T3 of the third sub-pixel area Sub3 is electrically connected with a next scanning line G2 adjacent to the scanning line G1 corresponding to the pixel area. A source of the third switch element T3 is electrically connected with the first terminal of the storage capacitor Cst2 of the second sub-pixel area Sub2. A drain of the third switch element T3 is electrically connected with a first terminal of the storage capacitor Cst3. A second terminal of each of the storage capacitor Cst1 and the storage capacitor Cst2 is electrically connected with a common line COM. A second terminal of the storage capacitor Cst3 of the third sub-pixel area Sub3 is electrically connected with the next scanning line G2 adjacent to the scanning line G1 corresponding to the pixel area.

Wherein, each of the first switch element T1, the second switch element T2, the third switch element T3 of the first sub-pixel area Sub1, the second sub-pixel area Sub2, and the third sub-pixel area Sub3 is realized by a thin-film-transistor.

The specific manufacturing process for the array substrate is: on a glass substrate, through exposing, developing, and etching to form a PEP1 (photo-etching-process) layer as a scanning line electrode and a common electrode. Forming a PEP2 layer at a location of a TFT (Thin Film Transistor). Utilizing a metal material to form a data line electrode and the TFT. Forming a conductive hole at a location which is required to be conductive, that is, a PEP4 layer. Finally, finishing a pixel electrode, that is, ITO layer (PEPS).

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A liquid crystal display panel, comprising:
a first substrate, having:
multiple scanning lines disposed on the first substrate;
multiple data lines disposed on the first substrate, wherein, the multiple scanning lines and multiple data lines are crossed with each other such that the liquid crystal display panel is divided into multiple pixel areas;
a second substrate disposed oppositely to the first substrate; and
a liquid crystal layer disposed between the first substrate and the second substrate;
wherein, each of the pixel areas includes a first sub-pixel area, a second sub-pixel area, and a third sub-pixel area; a driving voltage of the first sub-pixel area, a driving voltage of the second sub-pixel area, and a driving voltage of the third sub-pixel area are all generated from a data voltage provided by a same data line corresponding to the pixel area; when driving, the driving voltage of the first sub-pixel area is greater than the driving voltage of the second sub-pixel area, and the driving voltage of the second sub-pixel area is greater than the driving voltage of the third sub-pixel area.

2. The liquid crystal display panel according to claim 1, wherein, the first sub-pixel area and the second sub-pixel area are respectively connected with a scanning line corresponding to the pixel area and a data line corresponding to the pixel area such that the scanning line corresponding to the sub-pixel areas can control the first sub-pixel area and the second sub-pixel area to be turned on and turned off;
when the first sub-pixel area and the second sub-pixel area are turned on, using the data line corresponding to the pixel area to respectively input a data voltage into the first sub-pixel area and the second sub-pixel area;
the third sub-pixel area is connected with a next scanning line adjacent to the scanning corresponding to the pixel area such that the next scanning line can control the third sub-pixel area to be turned on and turned off;
after the data voltage is inputted into the first sub-pixel area and the second sub-pixel area and the third sub-pixel area is turned on, the second sub-pixel area charge the third sub-pixel area so as to pull down the driving voltage of the second sub-pixel area; and
when the third sub-pixel area is turned off, the third sub-pixel area pulls down the driving voltage of the third sub-pixel area according to an electric charge coupling effect.

3. The liquid crystal display panel according to claim 2, wherein, the first sub-pixel area includes a first switch element, a first liquid crystal capacitor, and a first storage capacitor; the second sub-pixel area includes a second switch element, a second liquid crystal capacitor, and a second storage capacitor; the third sub-pixel area includes a third switch element, a third liquid crystal capacitor, and a third storage capacitor;
wherein, both gates of the first switch element and the second switch element of the first sub-pixel area and the second sub-pixel area are electrically connected with the scanning line corresponding to the pixel area; both sources of the first switch element and the second switch element are electrically connected with the data line corresponding to the pixel area; a drain of the first switch element of the first sub-pixel area is electrically connected with a first terminal of each of the first liquid crystal capacitor and the first storage capacitor of the first sub-pixel area; a drain of the second switch element of the second sub-pixel area is electrically connected with a first terminal of each of the second liquid crystal capacitor and the second storage capacitor of the second sub-pixel area; and
a gate of the third switch element of the third sub-pixel area is electrically connected with the next scanning line adjacent to the scanning line corresponding to the pixel area; a source of the third switch element is electrically connected with the first terminal of each of the second liquid crystal capacitor and the second storage capacitor of the second sub-pixel area; a drain of the third switch element is electrically connected with a first terminal of each of the third liquid crystal capacitor and the third storage capacitor; a second terminal of each of the first storage capacitor and the second storage capacitor is electrically connected with a common line; a second terminal of the third storage capacitor of the third sub-pixel area is electrically connected with the next scanning line adjacent to the scanning line corresponding to the pixel area.

4. The liquid crystal display panel according to claim 3, wherein, the first switch element of the first sub-pixel area and the second switch element of the second sub-pixel area a same switching element.

5. The liquid crystal display panel according to claim 3, wherein, each of the first switch element, the second switch element, and the third switch element of the first sub-pixel area, the second sub-pixel area, and the third sub-pixel area is realized by a thin-film-transistor.

6. The liquid crystal display panel according to claim 4, wherein, each of the first switch element, the second switch element, and the third switch element of the first sub-pixel area, the second sub-pixel area, and the third sub-pixel area is realized by a thin-film-transistor.

7. The liquid crystal display panel according to claim 3, wherein, a pixel electrode of each pixel area is divided into a first sub-pixel electrode, a second sub-pixel electrode, and a third sub-pixel electrode; the first sub-pixel electrode, the second sub-pixel electrode, and the third sub-pixel electrode are respectively the first terminal of the first liquid crystal capacitor of the first sub-pixel area, the first terminal of the second liquid crystal capacitor of the second sub-pixel area, and the first terminal of the third liquid crystal capacitor of the third sub-pixel area; a common electrode of the pixel area is corresponding as the second terminal of the first liquid crystal capacitor of the first sub-pixel area, the second terminal of the second liquid crystal capacitor of the second sub-pixel area, and the second terminal of the third liquid crystal capacitor of the third sub-pixel area.

8. The liquid crystal display panel according to claim 4, wherein, a pixel electrode of each pixel area is divided into a first sub-pixel electrode, a second sub-pixel electrode, and a third sub-pixel electrode; the first sub-pixel electrode, the second sub-pixel electrode, and the third sub-pixel electrode are respectively the first terminal of the first liquid crystal capacitor of the first sub-pixel area, the first terminal of the second liquid crystal capacitor of the second sub-pixel area, and the first terminal of the third liquid crystal capacitor of the third sub-pixel area; a common electrode of the pixel area is corresponding as the second terminal of the first liquid crystal capacitor of the first sub-pixel area, the second terminal of the second liquid crystal capacitor of the second sub-pixel area, and the second terminal of the third liquid crystal capacitor of the third sub-pixel area.

9. The liquid crystal display panel according to claim 7, the pixel electrode and the common electrode of each pixel area are disposed on the first substrate.

10. The liquid crystal display panel according to claim 8, the pixel electrode and the common electrode of each pixel area are disposed on the first substrate.

11. An array substrate, comprising:
multiple scanning lines;
multiple data lines, wherein, the multiple scanning lines and multiple data lines are crossed with each other such that the array substrate is divided into multiple pixel areas;
wherein, each of the pixel areas includes a first sub-pixel area, a second sub-pixel area, and a third sub-pixel area; a driving voltage of the first sub-pixel area, a driving voltage of the second sub-pixel area, and a driving voltage of the third sub-pixel area are all generated from a data voltage provided by a same data line corresponding to the pixel area; when driving, the driving voltage of the first sub-pixel area is greater than the driving voltage of the second sub-pixel area, and the driving voltage of the second sub-pixel area is greater than the driving voltage of the third sub-pixel area.

12. The array substrate according to claim 11, wherein, the first sub-pixel area and the second sub-pixel area are respectively connected with a scanning line corresponding to the pixel area and a data line corresponding to the pixel area such that the scanning line corresponding to the sub-pixel areas can control the first sub-pixel area and the second sub-pixel area to be turned on and turned off;
when the first sub-pixel area and the second sub-pixel area are turned on, using the data line corresponding to the pixel area to respectively input a data voltage into the first sub-pixel area and the second sub-pixel area;
the third sub-pixel area is connected with a next scanning line adjacent to the scanning corresponding to the pixel area such that the next scanning line can control the third sub-pixel area to be turned on and turned off;
after the data voltage is inputted into the first sub-pixel area and the second sub-pixel area and the third sub-pixel area is turned on, the second sub-pixel area charge the third sub-pixel area so as to pull down the driving voltage of the second sub-pixel area; and
when the third sub-pixel area is turned off, the third sub-pixel area pulls down the driving voltage of the third sub-pixel area according to an electric charge coupling effect.

13. The array substrate according to claim 12, wherein, the first sub-pixel area includes a first switch element and a first storage capacitor; the second sub-pixel area includes a second switch element and a second storage capacitor; the third sub-pixel area includes a third switch element and a third storage capacitor;
wherein, both gates of the first switch element and the second switch element of the first sub-pixel area and the second sub-pixel area are electrically connected with the scanning line corresponding to the pixel area; both sources of the first switch element and the second switch element are electrically connected with the data line corresponding to the pixel area; a drain of the first switch element of the first sub-pixel area is electrically connected with a first terminal of the first storage capacitor of the first sub-pixel area; a drain of the second switch element of the second sub-pixel area is electrically connected with a first terminal of the second storage capacitor of the second sub-pixel area; and
a gate of the third switch element of the third sub-pixel area is electrically connected with the next scanning line adjacent to the scanning line corresponding to the pixel area; a source of the third switch element is electrically connected with the first terminal of the second storage capacitor of the second sub-pixel area; a drain of the third switch element is electrically connected with a first terminal of the third storage capacitor; a second terminal of each of the first storage capacitor and the second storage capacitor is electrically connected with a common line; a second terminal of the third storage capacitor of the third sub-pixel area is electrically connected with the next scanning line adjacent to the scanning line corresponding to the pixel area.
